(19) United States
(12) Patent Application Publication
(10) Pub. No.: US 2014/0291137 A1
(43) Pub. Date: Oct. 2, 2014

(54) CONTOURED HUMIDIFICATION-DEHUMIDIFICATION DESALINATION SYSTEM

(71) Applicants: Sean Anderson Barton, Tallahassee, FL (US); Robin Patrick Winton, Tallahassee, FL (US)

(72) Inventors: Sean Anderson Barton, Tallahassee, FL (US); Robin Patrick Winton, Tallahassee, FL (US)

(21) Appl. No.: 14/242,635

(22) Filed: Apr. 1, 2014

Related U.S. Application Data
(60) Provisional application No. 61/853,239, filed on Apr. 1, 2013.

(51) Int. Cl. B01D 3/00; C02F 1/04

(52) U.S. Cl. CPC B01D 3/00; C02F 1/04
USPC 202/185.2

(57) ABSTRACT

A humidification-dehumidification water desalination system uses a contoured interior chamber, essentially onion shaped, in order to balance the thermodynamics of the evaporation/condensation process completely by facilitating the needed fluid bypass with air and the contoured shape of the interior chamber so that the desalination can occur energy efficiently in a single stage humidification-dehumidification system. The contour of the internal wall of the interior chamber is loosely proportional to the differential of the percentage of water vapor that can be carried by air as a function of temperature, with the interior chamber being essentially symmetrical about a horizontal midplane through the interior chamber.

This application claims the benefit of U.S. provisional patent application, No. 61/853,239, filed on Apr. 1, 2013, which provisional patent application is incorporated herein by reference in its entirety.

### BACKGROUND OF THE INVENTION

1. Field of the Invention

The present invention relates to a humidification-dehumidification water desalination system that uses a single stage contoured evaporator/condenser.

2. Background of the Prior Art

Today multi-stage flash (MSF) and reverse osmosis (RO) are the two most commonly used technologies for water desalination. MSF is a vapor process where feed water initially is heated to its boiling point. As the water temperature drops and boiling stops, due to evaporative cooling, this water is then made to boil repeatedly by moving it from chamber to chamber, each chamber being at a progressively stronger vacuum until the water returns to its approximate original temperature. The produced steam is condensed, producing freshwater and releasing heat. The freshwater is collected and coils of metal tubing capture the heat for reuse within the system. By contrast, RO is a membrane process where feed water is forced at high pressure through a specialized membrane that blocks the passage of salt. Often this process is coupled with a pre-treatment facility that removes particulates in the water to improve the membranes' lifespan and performance. The total initial and long-term costs of these two technologies are similar, but the long-term cost for MSF and RO have different origins.

The primary cost of MSF is energy, as it consumes roughly 20 kW·h (Kilowatt-Hour) of electricity or 60 kW·h of steam heat per cubic meter of freshwater produced. Energy consumption of RO is much less (approx. 5 kW·h/m³), but the accumulation of mineral scale and particulate matter in RO reactors require the membrane cartridges to be replaced at regular intervals at great expense. (In an MSF reactor, mineral scaling requires a less-costly cleaning of the coils). Thus, the local price and availability of energy influence the economic choice between MSF and RO. Multi-stage flash desalination is common in the Middle East, where energy costs are relatively low, while in the United States, where energy costs are relatively higher, reverse osmosis desalination is preferred.

In MSF, sea water is heated up to the boiling point. It is then desired to continue boiling the water until all of the added heat has been used up by the evaporative cooling associated with the boiling. This returns the water to its original temperature. It takes approximately 92 Kilowatt-Hours of heat to heat up one cubic meter of water from room temperature to the normal boiling point. It then takes an additional approximately 627 Kilowatt-Hours of heat to then vaporize that same water without any further increase in temperature. The ratio of these two numbers, or about 15 percent, Is the fraction of water evaporated in a typical single pass through the MSF process.

So in MSF, the only way to force the water to continue boiling after its temperature has dropped below the boiling point is to reduce the pressure, and this is in fact what the MSF process does. When the water has lost so much heat that it will no longer boil at a particular temperature, the water is emitted into another boiling chamber at a lower pressure such that the water begins to boil anew, without the addition of any more heat. This “flashing” process is continued until the water's temperature has returned to roughly its original temperature, at which point it is discharged back to the saltwater source (usually the sea).

A major expense of this process is the requirement of so many different boiling chambers at so many different pressures, many of those pressures are significantly below the atmospheric pressure such that the boiling chamber must be heavily reinforced to prevent its implosion, they are essentially vacuum chambers.

In recent years, another vapor process has attracted research and development interest because of its simple, low-cost design. This process, called humidification-dehumidification (HDH) desalination, is more akin to the natural water cycle in that water is evaporated (not boiled) and recondensed in the presence of air. Since HDH does not use vacuum or other large pressure differences, robust chambers are not needed. The HDH process is economical at a small size, has low initial cost, and requires less maintenance than MSF or RO. Because of these attributes, HDH finds use in less-developed regions today. However, HDH has one major drawback—poorly balanced thermodynamics—resulting in much lower energy efficiency than even an MSF facility. Because of this issue, current HDH installations can only produce small amounts of freshwater.

HDH aims to eliminate the costly infrastructure of MSF by allowing the different temperatures of vaporizing water to co-exist at the same pressure. Though the partial pressure of the water vapor in the hottest area is much higher than the partial pressure of the water vapor in the colder area, because there is more partial pressure of air in the colder area to make up for the difference, the total pressure in the hot and cold areas can then be the same. It can in fact be nearly the same as the atmospheric pressure and thus costly reinforced containers and pressure barriers are not needed.

A particularly efficient arrangement for this type of process is to allow the hottest water to evaporate in an upper area and as the water cools, allow it to drain to a cooler lower area under the influence of gravity. Further, to prevent the air from becoming saturated with vapor, at which point evaporation stops, the air is passed through these evaporating areas. Fresh air is supplied to the coldest evaporating area and as it is becoming saturated with water vapor, it is moved upward to a warmer evaporating area where is will have an increased capacity to hold water vapor and can again take on more water vapor. Once the air has reached the uppermost hottest area, it is carried away to another process, the condensation process. Once some vapors have been condensed out of the air in the condenser, the air is returned to the coldest area of the evaporator for reuse. This is similar to what happens in a wet cooling tower. Hot water is admitted to the top of the tower while cold air is admitted to the bottom. As the water falls or percolates down through the tower, it is cooled by evaporation and by the air. Likewise, as the air rises through the tower, it is warmed and humidified by the water. Finally hot humid air is exhausted at the top of the tower. Cold water is emitted at the bottom.

The failure of this approach for water desalination is only seen when one attempts to reach high levels of energy efficiency.

It is a fact that air of a higher temperature has a greater capacity to carry water vapor. Or stated differently, water vapors of higher temperature are able to reach greater densities before they begin to condense into liquid water. The reason that the HDH approach fails from an energy efficiency standpoint is that this dependence of air's capacity to hold water vapor on temperature is not a linear relationship. To make a specific example, at 20 degrees Celsius, air can contain up to 2.3% water vapor, 30 degrees Celsius, this is 4.1% water vapor, at 40 degrees Celsius it is 7.4% water vapor, and at 50 degrees Celsius 12.3% water vapor.

The problem is this: the amount of vapor that the air can pick up between 20 and 30 Celsius is 4.1%−2.3%=1.8%, while the amount of vapor that the air can pick up between 30 and 40 Celsius is 7.4%−4.1%=3.3%, and the amount of vapor that the air can pick up between 40 and 50 Celsius is 12.3%−7.4%=4.9%

In a situation in which the falling water is providing the heat to power the vaporization of the water as in HDH, one must, select the right amount of water (the right number of gallons per minute) to provide the right amount of heat to power the vaporization. But this condition cannot both be satisfied in the hot top of the evaporator and the cold bottom of the evaporator at the same time with the same amount of air and water. Given a fixed amount of air flowing, if the correct amount of water is used to provide the right amount of heat in the top of the evaporator, then there is a surplus of heat in the bottom of the evaporator. Likewise if the amount of water is made correct for the bottom of the evaporator, then there is a shortage of water and heat at the top of the evaporator, if the top and bottom of the evaporator have the same air flow.

Multistage HDH (MSHDH) developed to address this issue. In MSHDH, there are a number of evaporators each seeing a different range of temperatures and using a different amount of water (or perhaps a different amount of air) such that the heat capacity of the water and the heat capacity of the air is roughly matched in a particular range of temperatures. MSHDH replaces the single evaporator and single condenser of HDH with a series of evaporators, a series of condensers, and a number of parallel water bypass or air bypass routes, forming a ladder-like arrangement. These air or water bypass routes allow different amounts of airflow or water flow in the various evaporators and condensers improving thermodynamic balance. While every added stage improves energy efficiency, it also increases complexity, initial cost, and minimum economical size, making the economics of MSHDH more similar to those of MSF. Therefore, the drive to improve the thermodynamic efficiency of HDH must focus on a single stage system.

### SUMMARY OF THE INVENTION

The contoured humidification-dehumidification water desalination system of the present invention addresses the aforementioned needs in the art by replacing the network of evaporators and condensers of MSHDH with a single unit evaporator/condenser that balances the thermodynamics of the process completely by facilitating the needed air bypass with a properly contoured porous solid material that transmits gas (air) in a laminar fashion and prevents mixing of the different temperatures found within the tower. The contoured humidification-dehumidification desalination system of the present invention addresses this need by creating this perfect match without removing air or water at any discrete levels in the evaporator. Numerical modeling shows that single-stage contoured humidification-dehumidification desalination system provides better energy efficiency than a several dozen-stage MSHDH. The contoured humidification-dehumidification desalination system retains the other benefits of HDH including the absence of vacuum, a small economical size, all without sacrificing its energy efficiency.

The contoured humidification-dehumidification desalination system of the present invention is comprised of a combined evaporation and condensation tower that has a first end, a second end longitudinally aligned with the first end, and a medial section that has a contoured portion. An evaporator is disposed within the tower proximate the first end and a condenser is disposed within the tower proximate the second end and is longitudinally aligned with the evaporator. A dry porous material is disposed within the contoured portion of the medial section of the tower such that the porous material is radially offset from the evaporator and the condenser and such that a carrier gas flows either between the first end and the second end of the tower or between the second end and the first end of the tower such that a portion of the carrier gas passes through the porous material. The geometry of the contoured area allows an essentially homogenous approach temperature throughout the evaporator and condenser. The evaporator is filled with a first fill material and allows for direct contact evaporation of a water vapor from a salt water body within the evaporator. The condenser is filled with a second fill material and allows for direct contact condensation of the water vapor with a fresh water body within the condenser. A thermal energy amount is applied to the salt water body such that a first portion of the thermal energy amount is transferred from the salt water body to the fresh water body (including some latent heat) and a second portion of the first portion is transferred from the fresh water body back to the salt water body outside of the tower. Alternately, the condenser is filled with a second fill material and allows for direct contact condensation of the water vapor with a water insoluble fluid, such as oil, within the condenser and a thermal energy amount is applied to the salt water body such that a first portion of the thermal energy amount is transferred from the salt water body to the water insoluble fluid in the tower and a second portion of the first portion is transferred from the water insoluble fluid back to the salt water body outside of the tower. As a further alternative, the condenser facilitates indirect contact heat exchange using at least one metal tube and to cool and condensate a water vapor flowing through the condenser and to heat salt water flowing inside the metal tube, wherein the evaporator facilitates direct contact evaporation of the water vapor from a salt water body, the evaporator is filled with a fill material. The contoured shape of the tower is chosen to create essentially homogenous temperature approach within the evaporator and condenser and prevent salt water crossover, such contour may include curves, straight edges, parallels, and non-parallels.

### BRIEF DESCRIPTION OF THE DRAWINGS

FIG. 1 is a schematic view of the contoured humidification-dehumidification water desalination system of the present invention.

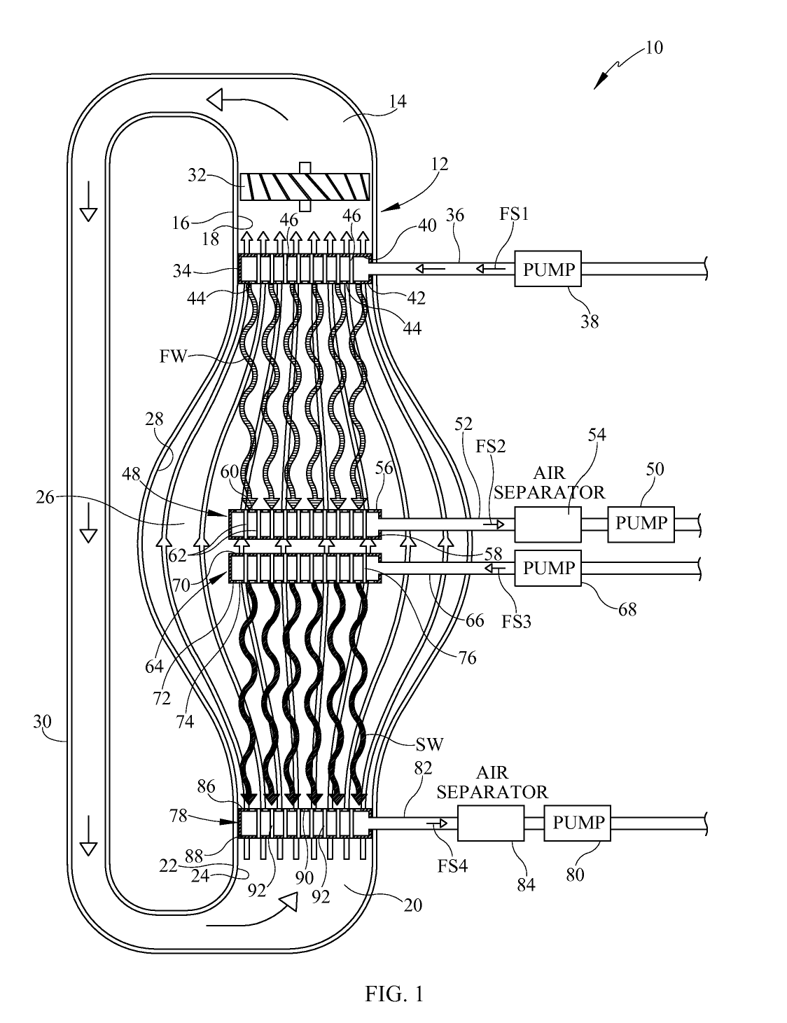

FIGS. 2-4 illustrate some of the shapes of the contoured tower that can be used with the contoured humidification-dehumidification water desalination system,

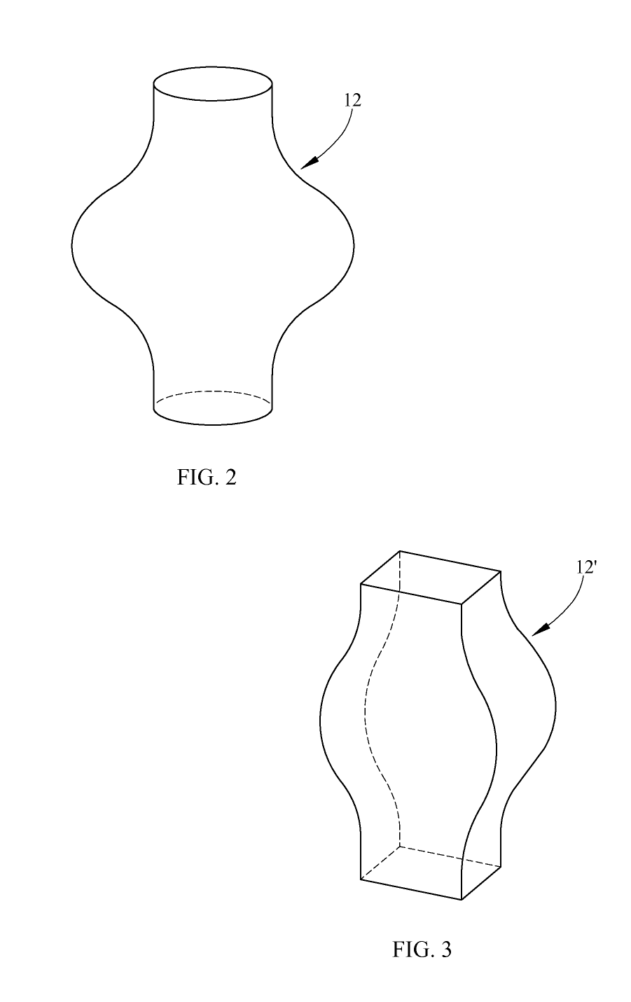

FIG. 5 illustrates the essentially homogenous approach temperature within the evaporator and condenser of the contoured humidification-dehumidification water desalination system in order to achieve the correct slope of the contouring of the inner wall of the tower

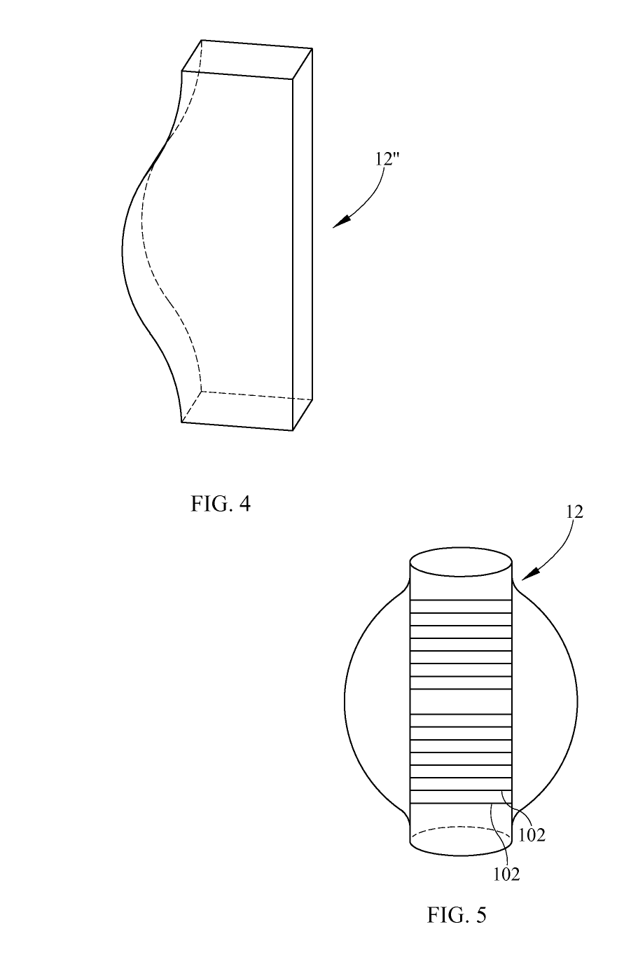

FIG. 6 is a schematic illustration showing the distribution of the fill material and porous material within the tower.

Similar reference numerals refer to similar parts throughout the several views of the drawings.

### DESCRIPTION OF THE PREFERRED EMBODIMENT

Referring now to the drawings, it is seen that the contoured humidification-dehumidification desalination system of the present invention, generally denoted by reference numeral 10, is comprised of a tower 12 which is a combined evaporator and condenser vessel that has an open top 14 having an upper neck portion 16 depending downwardly therefrom, the upper neck portion 16 having an internal wall 18 that is essentially straight, an open bottom 20 having a lower neck portion 22 depending upwardly therefrom, the lower neck portion 22 having an internal wall 24 that is essentially straight, and a main interior chamber 26 such that the internal wall 28 of the interior chamber 26 is essentially onion shaped in order to balance the thermodynamics of the process completely by facilitating the needed air bypass for a humidification-dehumidification desalination process.

As seen, a duct 30 fluid flow connects the open top 14 of the tower 12 with the open bottom 20 of the tower 12 with a fan 32 positioned within the upper neck portion 16 in order to generate the flow of air A.

A first distributor 34 is disposed within the upper neck 14 below the fan 32 (that is, the first distributor 34 is located between the fan 32 and the interior chamber 26), and secured thereat in appropriate fashion. A first conduit 36 delivers fresh, non-saline water FS1 to the first distributor 34, possibly with the assistance of a first pump 38. As seen the first distributor 34 has a first upper plate 40 and a generally coextensive first lower plate 42. The first lower plate 42 has a series of relatively small first water openings 44 thereon in order to allow the fresh water FW that accumulates within the first distributor 34 to pass therethrough, being gravitationally and pressure assisted in such passage. As also seen, the first lower plate 42 and the first upper plate 40 have a series of relatively larger (when compared to the first water openings 44) opening first tunnels 46 to allow the air stream S to rise through the corresponding first tunnels 62, thereby allowing the air AS and the water FW in this first distributor 34 to be kept at different volumes at different pressures and not allowed to mix.

A first collector 48 is disposed within the interior chamber 26 of the tower 12 and secured thereat in appropriate fashion just above the horizontal midplane of the interior chamber 26. A second pump 50 is fluid flow connected to the first collector 48 via an appropriate conduit 52 in order to draw freshwater FS2 out of the tower 12, with a first air separator 54 disposed therebetween in order to release any air bubbles from the fluid stream FS2. As seen the first collector 48 has a second upper plate 56 and a generally coextensive second lower plate 58. The second upper plate 56 has a series of relatively small second water openings 60 thereon in order to allow the fresh water FW to pass therethrough and into the first collector 48, being gravitationally and suction assisted in such passage. As also seen, the second upper plate 56 and the second lower plate 58 have a series of relatively larger (when compared to the second water openings 60) opening second tunnels 62 to allow the air stream S to rise through the corresponding second tunnels 62, thereby allowing the air AS and the water FW in this first collector 48 to be kept at different volumes at different pressures and not allowed to mix.

A second distributor 64 is disposed within the interior chamber 26 of the tower 12 and secured thereat in appropriate fashion just below the horizontal midplane of the interior chamber 26, and thus just below the first collector 48. A third conduit 66 delivers salt water FS3 to the second distributor 64, possibly with the assistance of a third pump 68. As seen the second distributor 64 has a third upper plate 70 and a generally coextensive third lower plate 72. The third lower plate 72 has a series of relatively small third water openings 74 thereon in order to allow the salt water SW that accumulates within the second distributor 64 to pass therethrough, being gravitationally and pressure assisted in such passage. As also seen, the third lower plate 72 and the third upper plate 70 have a series of relatively larger (when compared to the third water openings 74) opening third tunnels 76 to allow the air stream S to rise through the corresponding third tunnels 76, thereby allowing the air AS and the water SW in this second distributor 64 to be kept at different volumes at different pressures and not allowed to mix.

A second collector 78 is disposed within the lower neck 22 and secured thereat in appropriate fashion. A fourth pump 80 is fluid flow connected to the second collector 78 via an appropriate fourth conduit 82 in order to draw salt water FS4 out of the tower 12, with a second air separator 84 disposed therebetween in order to release any air bubbles from the fluid stream FS4. As seen the second collector 78 has a fourth upper plate 86 and a generally coextensive fourth lower plate 88. The fourth upper plate 86 has a series of relatively small fourth water openings 90 thereon in order to allow the salt water SW to pass therethrough and into the second collector 78, being gravitationally and suction assisted in such passage. As also seen, the fourth upper plate 86 and the fourth lower plate 88 have a series of relatively larger (when compared to the fourth water openings 90) opening fourth tunnels 92 to allow the air stream S to rise through the corresponding fourth tunnels 92, thereby allowing the air AS and the water SW in this second collector 78 to be kept at different volumes at different pressures and not allowed to mix.

It is expressly recognized that some or all of the pumps 38, 50, 68 and 80 may be optional and with the respective fluid stream being assisted by gravity or other water pumping source.

It is also expressly recognized that the various tunnels 46, 62, 76 and 92 may be eliminated and the air stream AS moves around the first distributor 34, the first collector 48, the second distributor 64 and the second collector 78, respectively.

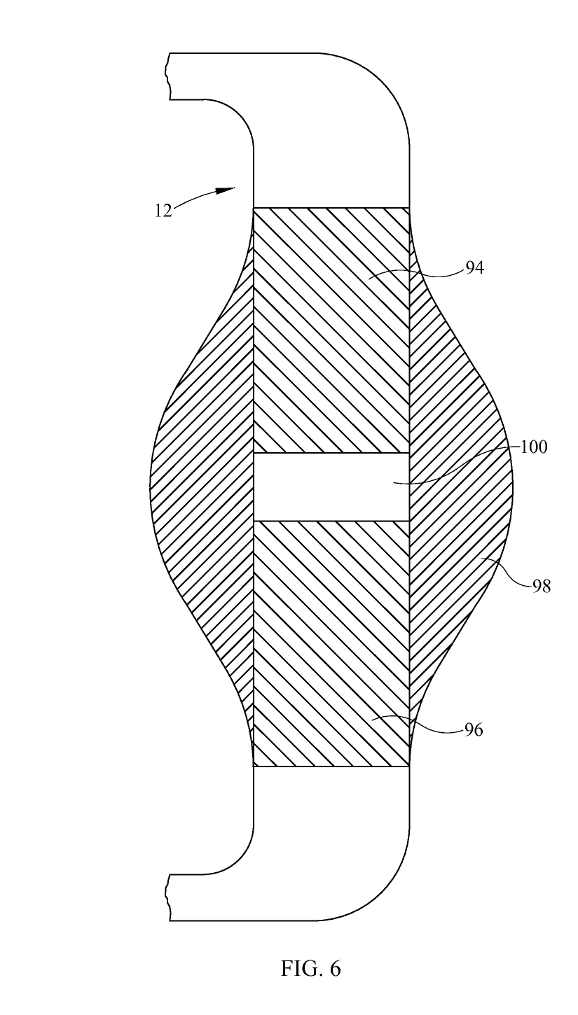

As seen in FIG. 6, the tower 12 is filled with appropriate materials, as is known in the art. In the condenser section 94 (between the first distributor 34 and the first collector 48), the fill material is coated with a falling film of fresh water FW, while the evaporator section 96 (between the second distributor 64 and the second collector 78), the fill material is coated with a falling film of salt water SW. In the bypass or contour area(s) 98, a dry porous packing material fills the area 98 and is dry and is not coated with any water and the collection zone 100 (the area between the first collector 48 and the second distributor 64), there is no fill material, making space for the first collector 48 and the second distributor 64. The dry porous material in the bypass area is for the purpose of resisting the airflow (carrier gas flow) and thereby forcing the airflow to flow in a laminar fashion so that the many different temperatures flowing in parallel do not mix with each other. The dry porous material also aids in capturing any mist of saltwater before the mist can reach the condensation area and contaminate the product water.

In operation of the contoured humidification-dehumidification desalination system 10 of the present invention, a fresh water stream FS1 is introduced into tower 12 through the first distributor 34 where in the fresh water FW percolates downwardly into the tower 12 by passing through the first water openings 44 of the first distributor 34. A salt water stream FS3 is introduced into the tower 12 through the second distributor 64 wherein the salt water SW percolates downwardly into the tower 12 by passing through the third water openings 74 of the second distributor 34. This salt water stream FS3 is heated prior to being introduced into the tower 12 in appropriate fashion, such as via a heat pump, a fuel powered heater, heat recovery from another process, especially the freshwater condensation process, solar energy, etc., (or some combination—none illustrated). Air A is continuously circulated through the tower 12 via the fan 32 that flows the air out from the tower 12 from the open top 14, through the duct 30 and back into tower 12 via the open bottom 20. While within the tower 12, the air stream AS moves upwardly through solid fill material and porous material packed interior chamber 26 and passes through the various air opening pairs 46 and 76 of the first distributor 34 and second distributor 64 respectively, and the various air opening pairs 62 and 92 of the first collector 48 and second collector 78 respectively. After the air stream AS moves upwardly from the open bottom 20, the air stream AS interacts with the heated salt water SW thereby causing some evaporation of salt water SW into the air stream AS. As the air stream passes through the second distributor 64 and first collector 48, the vapor laded warm air stream AS interacts with the cool fresh water FW flowing between the first distributor 34 and first collector 48 causing the air stream AS to cool and thus condensate out much of the water vapor being carried by the air stream, and thereby cooling the air stream AS. This water vapor that is condensated out of the air stream AS is picked up by the falling fresh water FW, which falling fresh water FW moves into the first collector 48 through the second water openings 60 wherein the fresh water FW is removed out of the tower 12 via the second conduit 52. Meanwhile, the falling salt water SW loses some of its heat to the evaporation of the water vapor therefrom due to the interaction with the air stream AS. The salt water SW moves into the second collector 78 through the fourth water openings 90 wherein the salt water S is removed out of the tower 12 via the fourth conduit 82. The salt water stream FS4 that is removed in such fashion can be discharged (for example, into the ocean), or recirculated back into the tower 12 via the third conduit 66, being reheated before such reentry.

Whether to recirculate the saltwater or to dump the salt water after exit from the tower 12 and use new saltwater back into the tower 12 depends upon many factors, such as the temperature differential of the outgoing salt water stream FS4 and the incoming salt water stream FS3, the filtration requirements (if the initial incoming heated salt water stream FS3 is particulate heavy, which particulates must be removed prior to entry into the tower 12, then the salt water may be recirculated in order to reduce the relatively expensive filtration costs), etc. Of course at some point, the salinity of the salt water will become so concentrated, that the outgoing salt water stream FS4 is discharged and a fresh salt water stream FS3 is introduced, all per well-known configurations known in the art.

The slope of the contour of the internal wall 28 of the main interior chamber 26 is loosely proportional to the second derivative of the percentage of water vapor that can be carried by air as a function of temperature for any given pressure, with the interior chamber 26 being essentially symmetrical about a horizontal midplane through the interior chamber 26.

This contour of the internal wall 28 of the interior chamber 26 follows from the temperature derivative of the ratio of water to air in saturated form (as opposed to the ratio of water to total (air and water) as was tabulated previously). Additional corrections to the contoured slope are required because the heat capacity of water is not perfectly independent of temperature, because the velocity of the air in contact with the water and the velocity of the air not in contact with water may be different, because volume capacity at fixed velocity is proportional to cross-sectional area not linear dimension and other physical details. In summary, the amount of air needed for heat capacity match at the hot center of the internal chamber 26 is less than the amount of air needed at the cold extremities, thus only part of the air that goes through the cold water should go through the hot water. The shape of the contours is thus precisely chosen so that the precisely correct amount of air passes through the water at various temperatures. Other small effects, like sideways movement of the water under the influence of the moving air may require additional corrections of the slope.

The slope is known to be correct when the approach temperatures 102 within the wet part of the tower 12 (the area outside the contour, namely the condenser section 94 and the evaporator section 96) are essentially homogenous as seen in FIG. 6. In order to understand essentially homogenous approach temperature, it is important to note that when exchanging heat (or mass) between two fluids, a small difference in temperature (or chemical potential) is needed to encourage the heat (or mass) to move from one fluid to the other. Thus, at all locations in a heat (or mass) exchanger (direct contact or indirect contact type) the heat (or mass) source fluid is at a slightly higher temperature (or chemical potential) than the heat (or mass) sink fluid. This small difference in temperature (between the heat source fluid and heat sink fluid) is commonly referred to as the “approach” in the chemical engineering industry. When the approach is large, heat moves rapidly from heat source fluid to heat sink fluid, however the higher required temperature of the heat source fluid increases energy costs somewhere else in the system. Thus large approaches lead to low system-wide energy efficiency. When the approach is small, heat moves slowly from the heat source fluid to the heat sink fluid and thus the fluids must remain in the heat exchanger longer to move the required amount of heat, thus requiring a larger more expensive heat exchanger or a lower capacity to move fluid volume through the exchanger. It is known that the additional energy consumed elsewhere in the system is approximately proportional to the approach and that the required size of the heat exchanger is approximately inversely proportional to the approach. Thus, to balance the goals of energy efficiency and compact size, some intermediate approach is chosen. If the approach is not kept constant through the process, then the additional energy consumed elsewhere follows from the average of these approaches. Similarly, if the approach varies, the required size of the heat exchangers is proportional to the average of the inverses of the approaches, it is not proportional to the inverse of the average of the approaches. Further, it is known mathematically that if one wishes to simultaneously minimize both the average of a population of numbers and the average of the inverse of the same population of numbers, that one must make all of the numbers in the population exactly the same. Thus, it can be mathematically seen that allowing the approach to vary throughout the heat exchanger increases required energy or required volume with no corresponding benefit. In a heat exchanger where fluid moves at a known velocity, one can use the variation of temperature with location to infer the rate of temperature change for the fluid traveling in that area. More specifically, if fluid velocity does not vary with position (as is the case for incompressible fluids in a parallel flow field) like is approximately true for the water percolating down through the top and bottom halves of the tower 12, one can immediately infer that the rate of temperature change for the fluid in a certain location is directly proportional to the temperature gradient in that location. This rate of temperature change is also directly proportional to the approach (assuming similar fluid properties (thermal conductivity, heat capacity, etc.) throughout). Thus, one identifies a tower contour in which approach is constant throughout by noticing that the temperature gradient (spacing of the isotherms) is approximately constant throughout. Water evaporating in air in a non-contoured evaporator tends to have a smaller approach in the middle and a larger approach at its extremities. This can be seen in a non-contoured evaporator by noticing that the isotherms are bunched together at the top and bottom and spread sparsely in the middle. The opposite is true for a non-contoured condenser. Isotherms are sparse (indicating low thermal gradient) at the extremities and dense (indicating high thermal gradient) in the middle. The contoured shape of the internal wall 28 of the interior chamber 26 of the tower 12 is thus chosen and re-chosen until the thermal gradient is found to be approximately uniform everywhere. The needed modification of the contour is roughly equal to the spatial derivative (gradient) of the isotherm density or gradient of the temperature gradient. Thus the tower may have any appropriate contoured shape so long as the approach temperature 102 within the evaporator 96, the condenser 94 and the collection zone 100 are essentially homogenous, including the onion shape tower 12, the flattened onion shaped tower 12′ as seem in FIG. 3, the flattened semi-onion shaped tower 12″ as seen in FIG. 4, etc. Additionally, other evaporation and condensation geometries are possible with the contoured tower 12, as it is the contouring of the tower 12 that allows some of the air flow within the tower to bypass the evaporator and the condenser in order to achieve high energy efficiency.

It is also possible to place a recirculation fan between the evaporator and condenser so that the air stream passing through the evaporator and condenser recirculates in the normal loop and the air stream through the bypass air recirculates (loops) therein.

While the invention has been particularly shown and described with reference to an embodiment thereof, it will be appreciated by those skilled in the art that various changes in form and detail may be made without departing from the spirit and scope of the invention.

We claim:

1. A humidification-dehumidification desalination system comprising:
a combined evaporation and condensation tower having a first end, a second end longitudinally aligned with the first end, and a medial section having a contoured portion, such that an evaporator is disposed within the tower proximate the first end and a condenser is disposed within the tower proximate the second end and longitudinally aligned with the evaporator; and
a porous material disposed within the contoured portion of the medial section of the tower such that the porous material is radially offset from the evaporator and the condenser such that a carrier gas flows either between the first end and the second end of the tower or between the second end and the first end of the tower such that a portion of the carrier gas passes through the porous material.

2. The humidification-dehumidification desalination system as in claim 1 wherein the geometry of the contoured area allows an essentially homogenous approach temperature through the evaporator and condenser.

3. The humidification-dehumidification desalination system as in claim 1 wherein the evaporator is filled with a first fill material and allows for direct contact evaporation of a water vapor from a salt water body within the evaporator.

4. The humidification-dehumidification desalination system as in claim 3 wherein the condenser is filled with a second fill material and allows for direct contact condensation of the water vapor with a fresh water body within the condenser.

5. The humidification-dehumidification desalination system as in claim 4 wherein a thermal energy amount is applied to the salt water body such that a first portion of the thermal energy amount is transferred from the salt water body to the fresh water body and a second portion of the first portion is transferred from the fresh water body back to the salt water body.

6. The humidification-dehumidification desalination system as in claim 3 wherein the condenser is filled with a second fill material and allows for direct contact condensation of the water vapor with a water insoluble fluid within the condenser.

7. The humidification-dehumidification desalination system as in claim 6 wherein a thermal energy amount is applied to the salt water body such that a first portion of the thermal energy amount is transferred from the salt water body to the fresh water body and a second portion of the first portion is transferred from the fresh water body back to the salt water body.

8. The humidification-dehumidification desalination system as in claim 1 wherein the condenser facilitates indirect contact heat exchange using at least one salt water filled metal tube and to cool and condensate a water vapor flowing through the condenser and wherein the evaporator facilitates direct contact evaporation of the water vapor from a salt water body, the evaporator if filled with a fill material.

9. The humidification-dehumidification desalination system as in claim 1 wherein the condenser is located gravitationally above the evaporator.

10. A contoured humidification-dehumidification desalination system comprising:
a combined evaporation and condensation tower having a first end, a second end longitudinally aligned with the first end, and a medial section, such that an internal wall within an interior of the tower at the medial section is outwardly contoured, the tower having a horizontal midline passing centrally through the contoured medial section;
a duct fluid flow connecting the first end of the tower and the second of the tower such that an air stream exits the tower at the first end, passes through the duct, and enters the tower at the second end;
a first distributor disposed within the tower proximate the top, the first distributor connected to a source of fresh water;
a first collector disposed within the medial section of the tower above the midline, the first collector fluid flow connected to a first conduit such that a condenser is defined between the first distributor and the first collector;
a second distributor disposed within the medial section of the tower below the midline, the second distributor fluid flow connected to a source of salt water having a temperature that is higher relative to the fresh water;
a second collector disposed within the tower proximate the bottom, the second collector fluid flow connected to a second conduit such that an evaporator is defined between the first distributor and the first collector; and
wherein the fresh water enters the tower through the first distributor wherein the fresh water gravitationally percolates through the first distributor and the salt water enters the tower through the second distributor wherein the salt water gravitationally percolates through the second distributor such that the air stream enters the bottom and moves up through the downwardly flowing salt water wherein the air stream is heated by the salt water and thereby causes a portion of the salt water to become an evaporate and upon passing up through the midline, the air stream flows through the downwardly flowing fresh water such that the heated air stream is cooled by the fresh water such that a portion of the evaporate condenses out of the air stream and is absorbed by the downwardly flowing fresh water, and such that the downwardly flowing fresh water is captured by the first collector and channeled out of the tower via the first conduit and the downwardly flowing salt water is captured by the second collector and channeled out of the tower via the second conduit.

11. The contoured humidification-dehumidification desalination system as in claim 10 wherein the shape of the contour is such that the approach temperature within the tower within the evaporator and the condenser is essentially homogenous.
